(19) United States
(12) Patent Application Publication
(10) Pub. No.: US 2024/0338881 A1
(43) Pub. Date: Oct. 10, 2024

(54) Application Programming Interface to Indicate Bounding Volume Output

(71) Applicant: MEDIATEK INC., Hsin-Chu (TW)

(72) Inventors: Chengping Luo, San Jose, CA (US); You-Ming Tsao, Hsinchu City (TW); Bozhan Chen, San Jose, CA (US); Sheng-Wen Huang, San Jose, CA (US)

(73) Assignee: MEDIATEK INC., Hsin-Chu (TW)

(21) Appl. No.: 18/624,166

(22) Filed: Apr. 2, 2024

Related U.S. Application Data
(60) Provisional application No. 63/494,491, filed on Apr. 6, 2023.

(51) Int. Cl. G06T 15/00; G06T 15/40; G06T 17/20

(52) U.S. Cl. CPC G06T 15/005; G06T 15/40; G06T 17/20; G06T 2210/12

(57) ABSTRACT

An application programming interface includes a mesh shader, a rasterizer, and a fragment shader. The mesh shader is used to process 3-dimensional objects and output vertices, primitives, and a plurality of bounding volumes of the 3-dimensional objects. The rasterizer is linked to the mesh shader, and used to project the vertices, the primitives, and the plurality of bounding volumes into 2-dimensional fragments. The fragment shader is linked to the rasterizer, and used to output a 2-dimensional image according to the 2-dimensional fragments.

### Cross Reference To Related Applications

This application claims the benefit of U.S. Provisional Application No. 63/494, 491, filed on Apr. 6, 2023. The content of the application is incorporated herein by reference.

### Background

A graphics processing unit, or GPU, is a specialized electronic circuit designed to accelerate the creation of images and video on a computer. It is essentially a co-processor to the main central processing unit (CPU), handling the heavy lifting of graphical tasks while the CPU takes care of other processes. GPU helps to improve performance and graphics quality by offloading some graphical processing from the CPU. Meanwhile, the GPU is so important mainly because it makes games run more efficiently and makes them look better with higher resolution graphics and improved frame rates. More particularly, GPU can render 2D and 3D graphics, animations, and video, enhance visual effects in games, movies, and other applications, power applications like image editing, video editing, and 3D modeling. GPU can also be used for non-graphical tasks like machine learning and scientific computing due to their parallel processing capabilities.

GPUs are designed for parallel processing, meaning they can handle many smaller tasks simultaneously, which makes GPUs much faster than CPUs in processing a large amount of graphical data. A GPU has its own dedicated memory. The CPU sends instructions to the GPU, and the GPU carries out those instructions and sends the results back to the CPU.

A shader is a piece of code or program that is executed on the GPU to manipulate an image before it is drawn to the screen. Shaders calculate the appropriate levels of light, darkness, and color during the rendering of a 3D scene. This process is known as shading. Shaders have evolved to perform a variety of specialized functions in computer graphics special effects and video post-processing, as well as general-purpose computing on GPU. Thus, the speed of shader execution or shader performance is crucial to GPU.

In 3D drawing, mesh refers to a geometric figure composed of vertices, lines, and surfaces. In the traditional drawing process, all meshes need to be drawn first before other steps can be performed, which becomes a performance bottleneck.

Mesh shader can operate the entire mesh with many small meshlets. It not only reduces bottlenecks through parallel operations, but also eliminates useless meshlets before drawing, thereby improving performance and reducing power consumption.

The pre-pass of vertex shader, which is designed to suppress the amount of geometry and vertex data before rendering, works well on splitting position and varying data however does not work efficiently with mesh shaders.

The size of output data from mesh shaders is dynamic and could be extremely large. It becomes the device memory and bandwidth bottlenecks especially for budgeted devices equipped with tiling GPUs and limited memory.

This invention aims to find a way to make the pipeline adopted and compatible to GPUs with and without tilers.

### Summary

An embodiment provides an application programming interface including a mesh shader, a rasterizer, and a fragment shader. The mesh shader is used to process 3-dimensional objects and output vertices, primitives, and a plurality of bounding volumes of the 3-dimensional objects. The rasterizer is linked to the mesh shader, and used to project the vertices, the primitives, and the plurality of bounding volumes into 2-dimensional fragments. The fragment shader is linked to the rasterizer, and used to output a 2-dimensional image according to the 2-dimensional fragments.

Another embodiment provides a method for application programming interface including a mesh shader processing 3-dimensional objects and output vertices, primitives, and a plurality of bounding volumes of the 3-dimensional objects, a rasterizer projecting the vertices, the primitives, and the plurality of bounding volumes into 2-dimensional fragments, and a fragment shader outputting a 2-dimensional image according to the 2-dimensional fragments.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an application programming interface of a GPU according to an embodiment of the present invention.

FIG. 2 is a flowchart of the method for an application programming interface in FIG. 1 according to an embodiment of the present invention.

FIG. 3 is an application programming interface of a tiling GPU according to an embodiment of the present invention.

FIG. 4 is a flowchart of the method for an application programming interface in FIG. 3 according to an embodiment of the present invention.

### DETAILED DESCRIPTION

In this disclosure, technical features that are individually described within one drawing may be implemented individually or simultaneously.

For terms and techniques not specifically described, reference may be made to technical standard documents issued before this specification.

A shader is a program that runs on the graphics processing unit (GPU) and determines how to render each pixel on the screen. Shaders can be used to create various visual effects, such as lighting, shadows, reflections, textures, animations, and more. Shaders are written in a special language called shading language, which is designed to work with the GPU's parallel architecture. Shaders can be divided into two main types: vertex shaders and fragment shaders. Vertex shaders operate on the vertices of a 3D model and transform their positions, colors, normals, and other attributes. Fragment shaders operate on the fragments (or pixels) of a 3D model and compute their final colors, depth, alpha, and other values.

A mesh shader is a kind of vertex shaders which can cut the entire mesh into many small meshlets. It not only reduces bottlenecks through parallel operations, but also eliminates useless meshlets before drawing, thereby improving performance and reducing power consumption.

This invention aims to find a way to make the pipeline adopted and compatible to GPUs with and without tilers.

Considerable solutions may include the following three options:
1. Define limited amount or size of vertices and primitives for task and mesh shader outputs.
2. Introduce a new resource type to encapsulate meshlets.
3. Mesh shaders output additional data with Bounding Volumes (BV) or axis-aligned bounding box (AABB) structure.

By limiting the maximum size of task and mesh shader outputs, tiling GPUs may have the opportunity to store all the subgroups in their own memories. However, it will oppositely suppress the scalability and flexibility of mesh shaders used with non-tiling GPUS which are claimed to have higher capacities than defined in the specification. Moreover the optimal output size of vertices and primitives depends highly on the GPU implementation, thus different GPUs will have different optimal output sizes.

To let the GPU driver know the size to be allocated precisely by using a new resource type, which effectively encapsulates all the static meshlets of a drawcall, is somehow a doable way for tiling GPU implementations to leverage the existing fixed-function input assembler and vertex shading passes. However, it brings a new different solution which is incompatible with the existing mesh shader, developers will suffer from extra overhead managing their geometry assets in a different way from those have been developed for the existing vertex shaders and mesh shaders. It clearly will not be a good choice for portability.

The last option is to reuse the existing task and mesh shaders with an additional bounding volume (BV) or Axis-aligned Bounding Box (AABB) output, enabling tiling GPUs to be more easily implemented with their early primitive culling for saving extra memory bandwidth during rendering, while it preserves the flexibility of using existing task shaders to do their own culling relied on the intension of developers' favor with non-tiling GPUs. With few changes in the mesh shaders, the geometry generation procedure and assets management working smoothly with the existing pipeline can be preserved mostly and reused with a runtime calculated bounding volume, given that developers will be easily porting their existing task and mesh shader algorithms onto devices with tiling GPUs. Thus option 3 is the best solution to the problem in this invention.

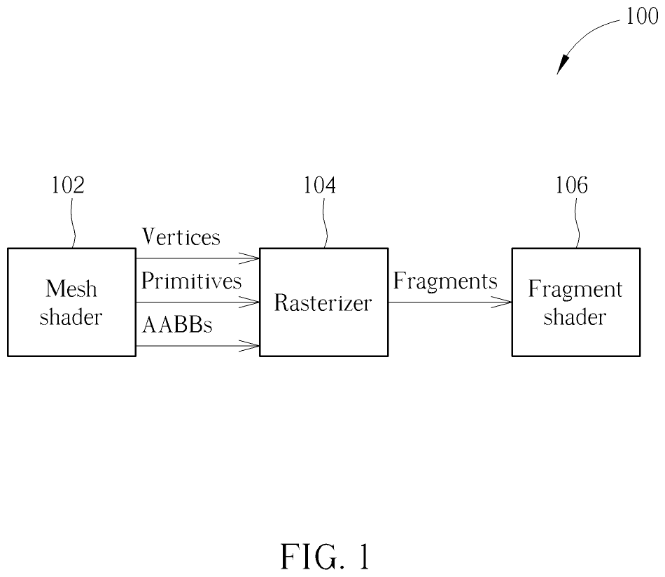

FIG. 1 is an application programming interface 100 of a GPU according to an embodiment of the present invention. The application programming interface 100 includes a mesh shader 102, a rasterizer 104, and a fragment shader 106. The mesh shader 102 is used to process 3-dimensional objects and output vertices, primitives, and a plurality of bounding volumes of the 3-dimensional objects. The plurality of bounding volumes can be a plurality of axis-aligned bounding boxes (AABBs). An AABB is defined by coordinates of a left-top-near point and coordinates of a right-bottom-far point. In an embodiment, coordinates of the left-top-near point are (2, 3, 4) and coordinates of the right-bottom-far point are (4, 1, 6), then, coordinates of the other 6 vertices can be generated according to these two points as (4, 3,4), (2, 1, 6), (2, 1, 4), (4, 3, 6), (2, 3, 6), and (4, 1, 4). Therefore, these eight vertices can represent one AABB by defining only coordinates of the left-top-near point and coordinates of the right-bottom-far point.

The rasterizer 104 is linked to the mesh shader 102, and is used to project the vertices, the primitives, and the plurality of bounding volumes into 2-dimensional fragments. The rasterizer 104 projects 3D objects to 2D fragments with depths so that the order of the 2D fragments can be depicted according to the 3D objects.

The fragment shader 106 is linked to the rasterizer 104, and is used to output a 2-dimensional image according to the 2-dimensional fragments. The fragment shader 106 can draw the 2D image according to the order of the 2D fragments to show the front parts of each 2D fragment and not show the useless parts of each 2D fragment. Therefore, an image of the 3D objects can be depicted as a 2D image.

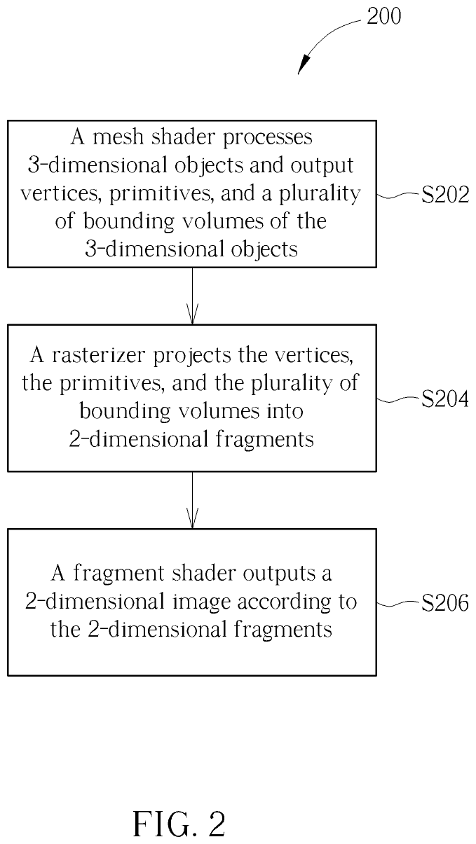

FIG. 2 is a flowchart of the method 200 for the application programming interface 100 of the GPU according to an embodiment of the present invention. The method 200 includes the following steps:

Step S202: the mesh shader 102 processes 3-dimensional objects and output vertices, primitives, and a plurality of bounding volumes of the 3-dimensional objects;

Step S204: the rasterizer 104 projects the vertices, the primitives, and the plurality of bounding volumes into 2-dimensional fragments; and

Step S206: the fragment shader 106 outputs a 2-dimensional image according to the 2-dimensional fragments.

In step S206, the fragment shader 106 may outputs a plurality of 2-dimensional images according to the 2-dimensional fragments instead of just one 2-dimensional image.

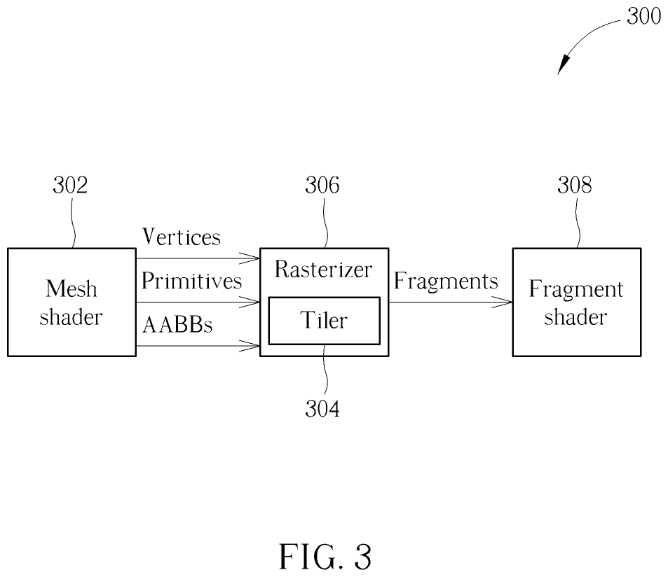

FIG. 3 is an application programming interface 300 of a tiling GPU according to an embodiment of the present invention. The application programming interface 300 of the tiling GPU includes a mesh shader 302, a rasterizer 306, and a fragment shader 308. The mesh shader 302 is used to process 3-dimensional objects and output vertices, primitives, and a plurality of bounding volumes of the 3-dimensional objects. The plurality of bounding volumes can be a plurality of axis-aligned bounding boxes (AABBs). An AABB is defined by coordinates of a left-top-near point and coordinates of a right-bottom-far point. In an embodiment, coordinates of the left-top-near point are (2,3,4) and coordinates of the right-bottom-far point are (4, 1, 6), then, coordinates of the other 6 vertices can be generated according to these two points as (4, 3, 4), (2,1,6), (2,1,4), (4, 3,6), (2, 3, 6), and (4, 1, 4). Therefore, these eight vertices can represent one AABB by defining only coordinates of the left-top-near point and coordinates of the right-bottom-far point.

The rasterizer 306 is linked to the mesh shader 302, and includes a tiler 304. The tiler 304 is linked to the mesh shader 302, and used to cut the vertices, the primitives, and the plurality of bounding volumes into small tiles or meshlets. The useless vertices and primitives contained in the plurality of bounding volumes can be culled at first to save computing resource and power consumption. In an embodiment, the bounding volumes or the AABBs with useless vertices and primitives can be deleted before rendering the vertices and primitives in the rasterizer 306, thus saving lots of computing resource. The rasterizer 306 then projects useful 3D objects to 2D fragments with depths so that the order of the 2D fragments can be depicted according to the 3D objects.

The fragment shader 308 is linked to the rasterizer 306, and is used to output a 2-dimensional image according to the 2-dimensional fragments. The fragment shader 308 can draw the 2D image according to the order of the 2D fragments to show the front parts of each fragment and not to show the useless parts of the 2D fragments. Therefore, an image of the 3D objects can be depicted as a 2D image.

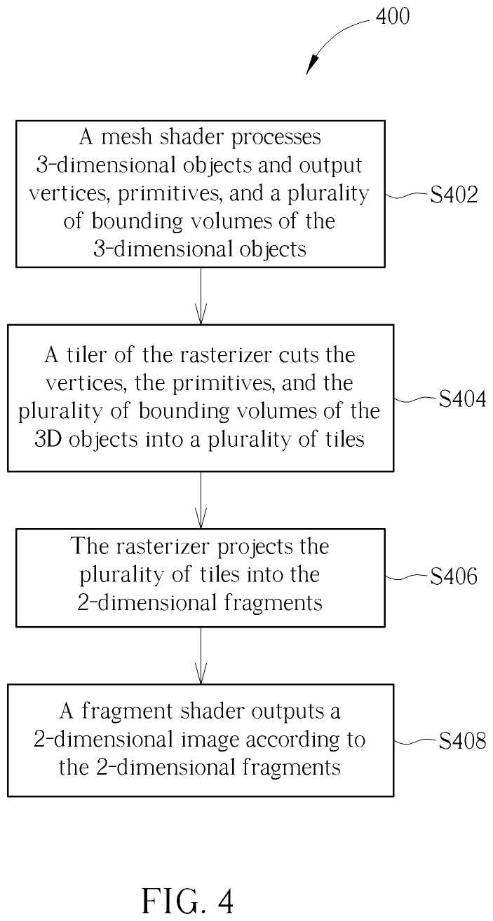

FIG. 4 is a flowchart of the method 400 for the application programming interface 300 of the tiling GPU according to an embodiment of the present invention. The method 400 includes the following steps:

Step S402: the mesh shader 302 processes 3-dimensional objects and output vertices, primitives, and a plurality of bounding volumes of the 3-dimensional objects;

Step S404: the tiler 304 of the rasterizer 306 cuts the vertices, the primitives, and the plurality of bounding volumes of the 3D objects into a plurality of tiles;

Step S406: the rasterizer 306 projects the plurality of tiles into the 2-dimensional fragments; and

Step S408: the fragment shader 308 outputs a 2-dimensional image according to the 2-dimensional fragments.

In conclusion, by using bounding volumes or AABBs in this invention, the computing consumption can be reduced, and the AABBs can be defined with only the left-top-near point and right-bottom-far point, thus saving the storage of memory. The invention finds a way to make the pipeline adopted and compatible to GPUs with and without tilers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An application programming interface, comprising:
a mesh shader, configured to process 3-dimensional objects and output vertices, primitives, and a plurality of bounding volumes of the 3-dimensional objects;
a rasterizer, linked to the mesh shader, and configured to project the vertices, the primitives, and the plurality of bounding volumes into 2-dimensional fragments; and
a fragment shader, linked to the rasterizer, and configured to output a 2-dimensional image according to the 2-dimensional fragments.

2. The application programming interface of claim 1, wherein:
the rasterizer comprises a tiler, linked to the mesh shader, and configured to cut the vertices, the primitives, and the plurality of bounding volumes into a plurality of tiles; and
the rasterizer projects the plurality of tiles into the 2-dimensional fragments.

3. The application programming interface of claim 2, wherein some of the plurality of bounding volumes are culled in the tiler.

4. The application programming interface of claim 1, wherein the plurality of bounding volumes are a plurality of axis-aligned bounding boxes (AABBs).

5. The application programming interface of claim 4, wherein each of the AABBs is defined by left-top-near coordinates and right-bottom-far coordinates.

6. The application programming interface of claim 1, wherein a plurality of primitives are within a bounding volume.

7. The application programming interface of claim 1, wherein a plurality of vertices are within a bounding volume.

8. The application programming interface of claim 1, wherein some of the plurality of bounding volumes are not rendered in the rasterizer.

9. A method for an application programming interface, comprising:
a mesh shader processing 3-dimensional objects and output vertices, primitives, and a plurality of bounding volumes of the 3-dimensional objects;
a rasterizer projecting the vertices, the primitives, and the plurality of bounding volumes into 2-dimensional fragments; and
a fragment shader outputting a 2-dimensional image according to the 2-dimensional fragments.

10. The method of claim 9, wherein the rasterizer projecting the vertices, the primitives, and the plurality of bounding volumes into the 2-dimensional fragments comprises:
a tiler of the rasterizer cutting the vertices, the primitives, and the plurality of bounding volumes of the 3D objects into a plurality of tiles; and
the rasterizer projecting the plurality of tiles into the 2-dimensional fragments.

11. The method of claim 10, further comprising:
culling some of the plurality of bounding volumes in the tiler.

12. The method of claim 9, wherein the plurality of bounding volumes are a plurality of axis-aligned bounding boxes (AABBs).

13. The method of claim 12, wherein each of the AABBs is defined by left-top-near coordinates and right-bottom-far coordinates.

14. The method of claim 9, wherein a plurality of primitives are within a bounding volume.

15. The method of claim 9, wherein a plurality of vertices are within a bounding volume.

16. The method of claim 9, wherein some of the plurality of bounding volumes are not rendered in the rasterizer.
